(19) United States
(12) Patent Application Publication
(10) Pub. No.: US 2009/0196013 A1
(43) Pub. Date: Aug. 6, 2009

(54) POINTER GAUGE ILLUMINATION

(76) Inventor: Samir Mezouari, Basildon (GB)

Correspondence Address: FRASER CLEMENS MARTIN & MILLER LLC, 28366 KENSINGTON LANE, PERRYSBURG, OH, 43551, US

(21) Appl. No.: 12/365,189

(22) Filed: Feb. 4, 2009

(30) Foreign Application Priority Data
Feb. 5, 2008 (GB) 0802096.8

(51) Int. Cl. G01D 11/28

(52) U.S. Cl. 362/26

(57) ABSTRACT

An illuminated display assembly includes a user display for displaying information to a user, wherein the user display includes a display medium and a movable display device having an indicator pointer for providing to the user a position indication on the display medium and an illumination source to emit an optical radiation for illuminating the indicator pointer and the display medium, wherein the movable display device includes a light pipe arranged to receive and convey the optical radiation from the illumination source, the light pipe having a dispersing feature arranged to disperse from the light pipe a first portion of the optical radiation to provide back illumination of the display medium and a second portion of the optical radiation conveyed by the light pipe to provide illumination of the indicator pointer.

### CROSS-REFERENCE TO RELATED APPLICATION

This application claims the benefit of United Kingdom Patent Application No. 0802096.8 filed on Feb. 5, 2008.

### FIELD OF THE INVENTION

The present invention relates to displays, in particular to displays having a backlit display medium together with a movable display device having an illuminated indicator pointer.

### BACKGROUND OF THE INVENTION

Vehicle displays often include backlighting used to provide illumination through clear or translucent portions of components forming the display. Examples include liquid crystal displays (LCD's), or indication displays having an applique with transparent or translucent portions through which the backlit illumination passes.

Examples in the field of automotive displays include LCD displays for displaying alphanumeric and graphical information, and speedometer or engine speed (rpm) displays having translucent numeric indications.

Traditionally, such displays have been illuminated with incandescent bulbs, although with the emergence of solid state light sources, there has been a considerable increase in the usage of light emitting diodes (LEDs), particularly white LEDs, because of their compact size and long lifetime.

The display is usually part of a display module seated inside a dashboard assembly. A depth of the display module may be limited because of the space required behind the display for wiring or ducting, and in any event it is desirable to limit the depth of the display.

Display modules comprise normally a rigid or flexible printed circuit carrier, for example printed flex strip or a rigid printed circuit board (PCB) with conduction tracks and components on one or both sides. In order to provide even backlight illumination over an area of the display, it may be necessary to use two or more lights spaced across the display. When incandescent bulbs are used, use of multiple bulbs may also be desirable because then there can be some overlap between the illumination provided by the bulbs so that when one bulb fails, a portion of the display does not go completely dark.

White LED's are, however, considerably more expensive than incandescent bulbs, and so it is in almost all cases uneconomic simply to replace each incandescent light with an LED. The manufacturing process for white LED's also leads to some inevitable hue variation in the shade of white produced by different LED's. This can lead to unpredictable color variations across a backlit display.

Therefore, the use of LED's in backlit display applications has in practice been limited to small area displays both for reasons of cost and for color uniformity.

It is an object of the present invention to provide a more convenient backlit display, which deals with at least some of these limitations.

It would be desirable to develop a display assembly and a method of providing diffuse backlit illumination to the display assembly wherein the display assembly and method provide a substantially uniform illumination of a display medium and an instrument pointer from a common illumination source.

### SUMMARY OF THE INVENTION

Concordant and consistent with the present invention, a display assembly and a method of providing diffuse backlit illumination to the display assembly wherein the display assembly and method provide a substantially uniform illumination of a display medium and an instrument pointer from a common illumination source, has surprisingly been discovered.

In one embodiment, an illuminated display assembly comprises: a user display for providing information to a user, wherein the user display includes a display medium and a movable display device having an indicator pointer for providing to the user a position indication on the display medium; and an illumination source emitting an optical radiation for illuminating the indicator pointer and the display medium, wherein the movable display device includes a light pipe arranged to receive and convey the optical radiation from the illumination source, the light pipe having a dispersing feature arranged to disperse from the light pipe a first portion of the optical radiation to provide back illumination of the display medium and a second portion of the optical radiation conveyed by the light pipe to provide illumination of the indicator pointer.

In another embodiment, an illuminated display assembly comprises: a user display for displaying information to a user, wherein the user display includes a display medium and a movable display device having an indicator pointer for providing to the user a position indication on the display medium; and an illumination source emitting an optical radiation for illuminating the indicator pointer and the display medium, wherein the movable display device includes a light pipe arranged to receive and convey the optical radiation from the illumination source, the light pipe having a dispersing feature arranged to disperse from the light pipe a first portion of the optical radiation to provide back illumination of the display medium and a second portion of the optical radiation conveyed by the light pipe to provide illumination of the indicator pointer; and a motive means for rotationally moving the movable display device about a rotational axis, wherein the light pipe extends along the rotational axis.

The invention also provides methods of providing diffuse backlit illumination to a display assembly, the display assembly including a user display having a display medium and a movable display device, wherein the moveable display device includes an indicator pointer, a source of optical radiation for backlighting the user display, and a light pipe having a dispersing feature.

One method comprises the steps of: using the source of optical radiation to generate the optical radiation; projecting from behind the user display the optical radiation into the light pipe; conveying the optical radiation within the light pipe; using the dispersing feature of the light pipe to disperse a first portion of the optical radiation out of the light pipe; using the dispersed first portion of the optical radiation to back illuminate the display medium; and conveying within the light pipe a second portion of the optical radiation remaining after the dispersing of the first portion to illuminate the indicator pointer.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings in which:

FIG. 1 shows a vehicular dashboard display assembly, comprising a central dial display according to the present invention, including a backlit display medium and a rotational indicator pointer;

FIG. 2 is a schematic cross-sectional view of a portion of the dial display and the indicator pointer of FIG. 1, wherein light for back illumination of the dial display is dispersed by a constriction in a light pipe;

FIG. 3 is a schematic cross-sectional view of a portion of a dial display and a rotational indicator pointer similar to that of FIG. 2, according to a second embodiment of the present invention, wherein light for back illumination of the dial display is dispersed by a plurality of triangular steps in a light pipe;

FIG. 4 is a schematic cross-sectional view of a portion of a dial display and a rotational indicator pointer similar to that of FIG. 2, according to a embodiment of the present invention, wherein light for back illumination of the dial display is dispersed by an uneven surface in a light pipe; and

FIG. 5 is a schematic cross-sectional view of a portion of a dial display and rotational indicator pointer similar to that of FIG. 2, according to a fourth embodiment of the invention, wherein light for back illumination of the dial display is dispersed by a coarse surface in a light pipe.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

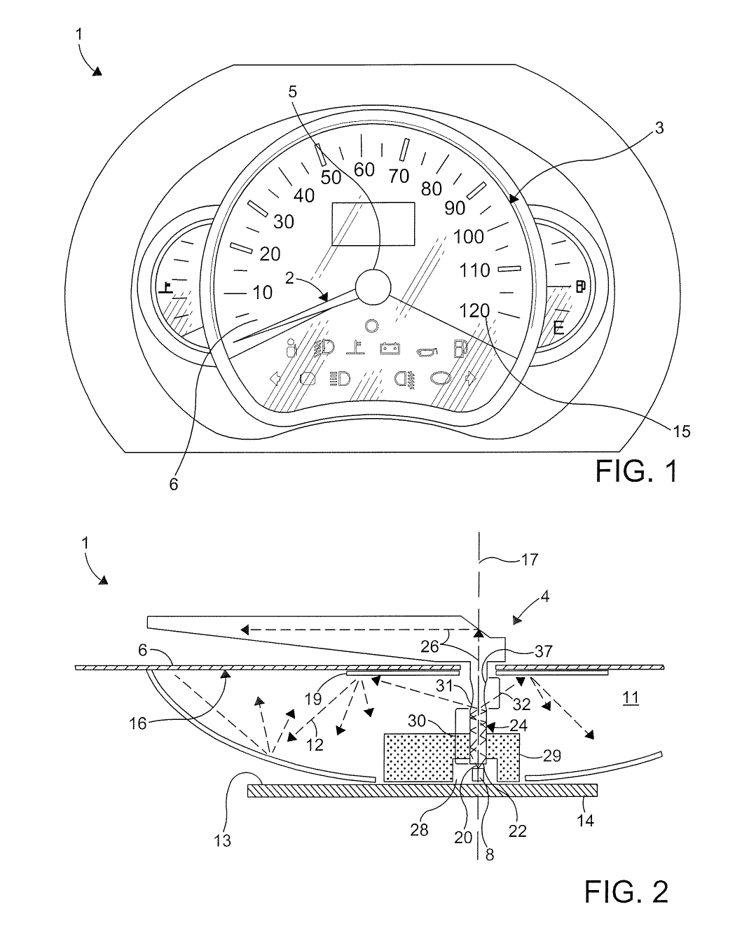

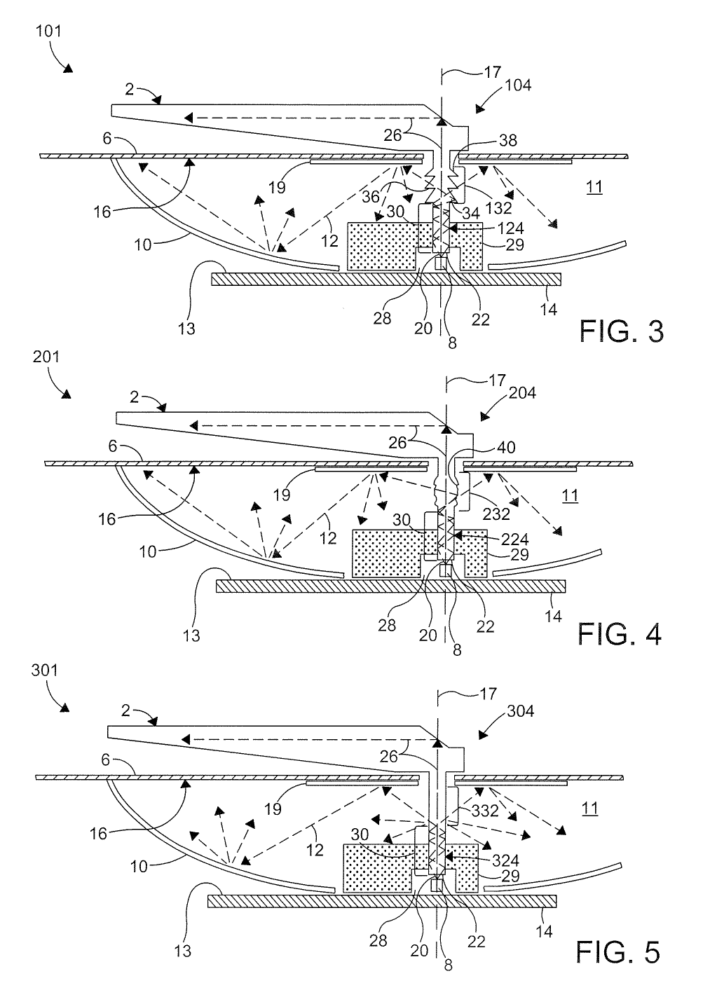

With reference to FIG. 1, a vehicular dashboard display assembly 1, includes a plurality of user display units, including a central dial display 3, which in this example is a speedometer display. The central dial display 3 is backlit so that a user can see alphanumeric or graphical information 15 presented by a partially translucent display medium 6. Positions or information, here speed indications, on the dial display 3 are indicated by an indicator pointer 2 or pointer flag which rotates about a central hub 5. As shown in FIGS. 2-5, the speed indicator pointer 2 is part of a movable display device 4, 104, 204, 304 and functions as a movable display flag for providing to a user different position indications on the display medium 6 representative of vehicle speed.

FIGS. 2-5 show schematically the workings of four specific embodiments of the display assembly 1, 101, 201, 301. Each embodiment has: the partially translucent display medium 6 for displaying eye-visible information to a user of the display assembly 1, 101, 201, 301; an illumination source 8 of visible optical radiation for backlighting the display medium 6; a main or primary annular light diffuser 10 disposed adjacent a rear surface 16 of the display medium 6 for diffusing a first portion of optical radiation 12 which is incident on the primary diffuser 10; and a printed circuit board (PCB) carrier 14 which supports the illumination source 8. The primary diffuser 10 is formed from a substantially opaque white plastic material and is optically closest to the display medium 6 so that in use this diffuses visible light towards a rear surface 16 of the display medium in order to provide backlight illumination. As shown, the primary diffuser 10 is arc-shaped and has a concave diffusing surface 9 that extends around a central portion of the display medium 6.

The illumination source 8 is a single white LED positioned on a rotational axis 17 of the movable display device 4, 104, 204, 304. However, it is understood that any source of illumination may be used such as a solid state light source. It is further understood that any number of the illumination sources 8 may be used. As shown, the illumination source 8 is disposed in a recess 28 formed in an electric stepper motor 29, which when activated rotates the movable display device 4, 104, 204, 304. The motor 29 is also mounted on the PCB carrier 14. Although not illustrated, the PCB carrier 14 provides electrical signals to both the illumination source 8 and the motor 29 in order to control an angular position of the indicator pointer 2. In certain embodiments, the PCB carrier 14 has plated tracks on only a single side, so that display components, connectors or circuitry are all provided on the same side of the PCB carrier 14, preferably a side 13 nearest the display medium 6.

The primary diffuser 10 is spaced behind the display medium 6 from the vantage point of a user of the display assembly 1. The primary diffuser 10 does not need to extend a full 360° degrees around the axis 17, but preferably extends approximately the same angular distance as the portion of the display medium 6 to be backlit. As a non-limiting example, the graphical information 15 in the form of numerical backlit indicia extend over an arc of about 270° around the central dial display 3, and so the primary diffuser 10 should extend at least this angular distance, and preferably about 320°.

The primary diffuser 10 is part of an “open box” type light diffuser 11, which will, in general, have other light diffusing surfaces which are secondary in the sense of being optically further from the display medium 6, in particular a secondary light diffuser 19 which is an opaque white paint applied to the rear surface 16 of the display medium 6 directly around the central axis 17.

The four illustrated embodiments of the display assembly 1, 101, 201, 301 differ from each other in the form of the movable display device 4, 104, 204, 304 that is employed in each embodiment. Each movable display device 4, 104, 204, 304 has the same form of the indicator pointer 2, but has a different type of a light pipe 24,124, 224, 324 for conveying a second portion 26 of the optical radiation 20 into the indicator pointer 2. Each indicator pointer 2 is either integrally molded or optically joined with the respective light pipe 24 124, 224, 324, so that the indicator pointer is unitary therewith.

The light pipe 24 124, 224, 324 is ideally transparent. Although not illustrated, the indicator pointer 2 may incorporate a fluorescent dye or be painted with a material which catches or directs a part of the optical radiation 20 so that the indicator pointer 2 is visible to a user in dim ambient lighting conditions.

The light pipe 24, 124, 224, 324 extends along the axis 17 in a direction away from the illumination source 8 mounted on the PCB carrier 14. The motor 29 has a cylindrical socket 33 which receives an endmost portion or end surface 22 of the light pipe 24, 124, 224, 324 and which extends into the recess 28 to provide a path for the optical radiation 20 from the illumination source 8 to reach the light pipe 24,124, 224, 324. The light pipe 24, 124, 224, 324 is therefore directly rotated by the motor 29.

The illumination source 8 thereby projects the optical radiation 20 into the end surface 22 of the light pipe 24, 124, 224, 324 which lies in a plane at right angles to the axis 17. The light pipe 24,124, 224, 324 may be formed from a polycarbonate or acrylic plastic material having an index of refraction of approximately 1.5, and so has a critical angle of about 42° from a normal to a cylindrical smooth-walled portion 30 of the light pipe 24, 124, 224, 324. The optical radiation 20 is therefore conveyed along the light pipe 24, 124, 224, 324 towards a dispersing feature 32, 132, 232, 332 arranged to disperse the first portion 12 of the optical radiation 20 laterally outwards from the light pipe 24, 124, 224, 324.

In the first embodiment of the display assembly 1, the dispersing feature 32 is a gradual smooth constriction 31 in a cross-sectional area of the light pipe 24 in a plane transverse to the axis 17. The constriction 31 has the effect of decreasing the internal angle of incidence (relative to a normal to the wall) so that rays which were previously constrained can escape by Fresnel refraction to provide the first portion 12 of the optical radiation 20 to back-illuminate the display portion 6. The constriction 31 is then smoothly reversed in an expanding portion 37, so that any remaining part of the optical radiation 20 proceeds along the light pipe 24 to provide the second portion 26 of the optical radiation 20 to illuminate the indicator pointer 2.

It should be appreciated that much of the first portion 12 of the optical radiation 20 will be incident on the secondary light diffuser 19 and then will be scattered generally towards the primary diffuser 10. Other components within the light box diffuser 11 such as the motor 29 may be painted or colored white or silver, in order to increase the amount of the first portion 12 optical radiation 20 that is scattered or reflected towards the rear surface 16 of the display medium 6.

The second embodiment of the display assembly 101 differs from the first embodiment of the display assembly 1 in that the dispersing feature 132 of the light pipe 124 is provided with at least one asymmetric triangular step 34. As shown, there are three steps 34. However, any number of steps may be used. Each of the steps 34 has nearest the illumination source 8 an annual ledge 36 that projects radially away at right angles to the axis 17, followed by a conical shoulder 38 that tapers radially inwards in the direction away from the illumination source 8. The critical angle for internally incident optical radiation is reduced at the conical shoulder 38 with the result that the first portion 12 of the optical radiation 20 can escape from the light pipe 124 at the conical shoulders 38.

In the third embodiment of the display assembly 201, the diffusing feature 232 is a rough, uneven surface texture 40, and in the fourth embodiment of the display assembly 301, the diffusing feature 332 is provided by scattering particles or by painting stripes on the light pipe 324 to help extract the first portion 12 of the optical radiation 20 from the light pipe 224, 324.

Internal light diffusing components of the display assembly 1,101, 201, 301, in particular the primary diffuser 10 may be formed from an opaque and diffusing material, for example acrylonitrile butadiene styrene (ABS). Preferably, both the primary diffuser 10 and the secondary light diffuser 19, are made from materials which have a high light scattering ability or reflectance within the spectrum of the illumination source 8.

It should be noted that the dispersing feature 32, 132, 232, 332 extends fully around the rotational axis 17. The dispersed first portion 12 of the optical radiation 20 is therefore unaffected by the rotation of the light pipe 24, 124, 224, 324.

The present invention therefore uses a symmetrical optical arrangement relative to the axis 17 to achieve an even illumination without the need to vary the transmittance of the graphical information display medium 6. The invention therefore provides a useful balancing technique for achieving even illumination in a dial display.

The light pipe 24, 124, 224, 324 may serve as a rotational shaft of the movable display device 4, 104, 204, 304 and in use is rotated by the motor 29 without the need for any additional mechanical drive components. The light pipe 24, 124, 224, 324 therefore conveys both illumination and provides for rotational movement of the indicator pointer 2, which simplifies the mechanical arrangement of the user display assembly 1, 101, 201, 301.

In each of the embodiments described above, the first portion 12 of the optical radiation 20 is dispersed radially outwards around the rotational axis 17 to provide the back illumination of the display medium 6. As the display medium 6 has display indicia or graphical information 15 arranged around the rotational axis 17, the graphical information 15 is back illuminated by the first portion 12 of the optical radiation 20. The remaining second portion 26 of the optical radiation 20 in the light pipe 24, 124, 224, 324 is therefore available to illuminate the indicator pointer 2.

In the preferred embodiments of the invention, the light pipe 24, 124, 224, 324 is integrally formed together with the indicator pointer 2 from a substantially transparent plastic material. The dispersing feature 32, 132, 232, 332 may be provided by a shaping or a texturing of an external surface of the light pipe 24, 124, 224, 324.

As a non-limiting example, the display assembly 1, 101, 201, 301 uses a common illumination source 8 which, in the examples described above, is a single solid state light source, preferably a white or a colored LED, positioned approximately centrally with respect to the display medium 6. This results in a decrease in the complexity and cost of the lighting arrangement, and, in the case of a white LED, an improvement in the white color balance of the display assembly.

Compared with conventional backlight systems, in which illumination from a number of separate light sources is diffused at various points around a display dial and separately introduced into a dial pointer, the display assembly 1, 101, 201, 301 and method of providing diffuse backlit illumination to the display assembly 1, 101, 201, 301 provides a diffusing of light from a reduced number of backlight sources, and most preferably just one backlight source.

The invention therefore provides a convenient and economical backlit display unit comprising a backlit display medium together with a movable display device having an illuminated pointer flag.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. An illuminated display assembly comprising:
a user display for providing information to a user, wherein the user display includes a display medium and a movable display device having an indicator pointer for providing to the user a position indication on the display medium; and
an illumination source emitting an optical radiation for illuminating the indicator pointer and the display medium, wherein the movable display device includes a light pipe arranged to receive and convey the optical radiation from the illumination source, the light pipe having a dispersing feature arranged to disperse from the light pipe a first portion of the optical radiation to provide back illumination of the display medium and a second portion of the optical radiation conveyed by the light pipe to provide illumination of the indicator pointer.

2. The illuminated display assembly according to claim 1, further comprising at least one light diffuser disposed adjacent the display medium, wherein the at least one light diffuser is positioned to receive and diffuse at least a part of the first portion of the optical radiation.

3. The illuminated display assembly according to claim 2, wherein the at least one light diffuser is arc-shaped and has a concave diffusing surface.

4. The illuminated display assembly according to claim 1, wherein the illumination source is a single light source.

5. The illuminated display assembly according to claim 1, wherein the illumination source is a solid state light source.

6. The illuminated display assembly according to claim 1, wherein the illumination source includes a single light emitting diode.

7. The illuminated display assembly according to claim 1, wherein the illumination source is substantially centrally positioned with respect to the display medium.

8. The illuminated display assembly according to claim 1, wherein the light pipe includes a substantially transparent solid material defining an external wall of the light pipe, the optical radiation conveyed by the light pipe constrained within the light pipe by total internal reflection by the external wall, and wherein the dispersing feature is a shape of the external wall of the light pipe which permits the first portion of the optical radiation to be transmitted through the external wall.

9. The illuminated display assembly according to claim 8, wherein the shaping of the external wall creates a constriction in cross-sectional area of said light pipe in a plane transverse to the direction in which the optical radiation is conveyed within the light pipe.

10. The illuminated display assembly according to claim 8, wherein the shape of the external wall includes at least one step.

11. The illuminated display assembly according to claim 1, wherein the light pipe includes a substantially transparent solid material defining an external wall of the light pipe, the optical radiation conveyed by the light pipe constrained by the light pipe by total internal reflection with the external wall, and wherein the dispersing feature is a texturing of the external wall of the light pipe which permits the first portion of the optical radiation to be transmitted through the external wall.

12. The illuminated display assembly according to claim 1, wherein the light pipe is formed as a unitary structure with the indicator pointer.

13. An illuminated display assembly comprising:
a user display for displaying information to a user, wherein the user display includes a display medium and a movable display device having an indicator pointer for providing to the user a position indication on the display medium; and
an illumination source emitting an optical radiation for illuminating the indicator pointer and the display medium, wherein the movable display device includes a light pipe arranged to receive and convey the optical radiation from the illumination source, the light pipe having a dispersing feature arranged to disperse from the light pipe a first portion of the optical radiation to provide back illumination of the display medium and a second portion of the optical radiation conveyed by the light pipe to provide illumination of the indicator pointer; and
a motive means for rotationally moving the movable display device about a rotational axis, wherein the light pipe extends along the rotational axis.

14. The illuminated display assembly according to claim 13, further comprising at least one light diffuser disposed adjacent the display medium, wherein the at least one light diffuser is positioned to receive and diffuse at least a part of the first portion of the optical radiation.

15. The illuminated display assembly according to claim 14, wherein the at least one light diffuser is arc-shaped and has a concave diffusing surface.

16. The illuminated display assembly according to claim 13, wherein the motive means and the illumination source are mounted on a common circuit board.

17. The illuminated display assembly according to claim 13, wherein the light pipe is a rotational shaft of the movable display device, the shaft adapted to be rotated by the motive means.

18. The illuminated display assembly according to claim 13, wherein the first portion of the optical radiation is dispersed radially outwards around the rotational axis to provide the back illumination of the display medium.

19. The illuminated display assembly according to claim 18, wherein the display medium has display indicia arranged around the rotational axis, the display indicia being back illuminated by the first portion of the optical radiation.

20. A method of providing diffuse backlit illumination to a display assembly, the display assembly including a user display having a display medium and a movable display device, wherein the moveable display device includes an indicator pointer, a source of optical radiation for backlighting the user display, and a light pipe having a dispersing feature, the method comprising the steps of:
using the source of optical radiation to generate the optical radiation;
projecting from behind the user display the optical radiation into the light pipe;
conveying the optical radiation within the light pipe;
using the dispersing feature of the light pipe to disperse a first portion of the optical radiation out of the light pipe;
using the dispersed first portion of the optical radiation to back illuminate the display medium; and
conveying within the light pipe a second portion of the optical radiation remaining after the dispersing of the first portion to illuminate the indicator pointer.
